(19) United States
(12) Patent Application Publication
(10) Pub. No.: US 2017/0242285 A1
(43) Pub. Date: Aug. 24, 2017

(54) DISPLAY SUBSTRATE ASSEMBLY, DISPLAY PANEL AND ITS MANUFACTURING METHOD, AND DISPLAY DEVICE

(71) Applicants: BOE TECHNOLOGY GROUP CO., LTD., Beijing (CN); HEFEI XINSHENG OPTOELECTRONICS TECHNOLOGY CO., LTD., Anhui (CN)

(72) Inventors: Liangliang JIANG, Beijing (CN); Lei GUO, Beijing (CN); Yongcan WANG, Beijing (CN)

(73) Assignees: BOE TECHNOLOGY GROUP CO., LTD., Beijing (CN); HEFEI XINSHENG OPTOELECTRONICS TECHNOLOGY CO., LTD., Anhui (CN)

(21) Appl. No.: 15/235,993

(22) Filed: Aug. 12, 2016

(30) Foreign Application Priority Data
Feb. 19, 2016 (CN) 201610094698.7

(51) Int. Cl. G02F 1/1339; G02F 1/1341; G02F 1/1368

(52) U.S. Cl. CPC G02F 1/13394; G02F 1/1368; G02F 1/1341; G02F 2001/13396; G02F 2001/136222

(57) ABSTRACT

The present disclosure provides a display substrate assembly, a display panel and its manufacturing method, and a display device. The display substrate assembly comprises a display substrate, a first spacer and a second spacer arranged at one side of the display substrate wherein a height of the first spacer is no greater than a height of the second spacer, and a pressure-sensitive adhesive layer arranged at an end of the second spacer away from the display substrate. The present disclosure can prevent slip of the second spacer when the display panel is subjected to a horizontal external force.

### CROSS-REFERENCE TO RELATED APPLICATION

This application claims a priority to Chinese Patent Application No. 201610094698.7 filed on Feb. 19, 2016, the disclosures of which are incorporated in their entirety by reference herein.

### TECHNICAL FIELD

The present disclosure relates to the field of liquid crystal display, in particular to a display substrate assembly, a display panel and its manufacturing method, and a display device.

### BACKGROUND

At present, in a liquid crystal display panel, the display panel is formed by injecting liquid crystal (LC) between an array substrate and a color filter (CF) substrate. During the manufacturing of the liquid crystal display panel, a cell gap between the CF substrate and the array substrate is adjusted by controlling the amount of liquid crystal between the two substrates, so as to control the brightness and transmittance of the display panel in optical aspect.

In order to maintain a uniform cell gap in respective positions between the array substrate and the CF substrate in the whole plane of the liquid crystal display panel, it is a main means adopted in the related art to arrange post spacers (PS) on a black matrix of the CF substrate. In early liquid crystal panels, the spacers have identical heights. However, due to further extensive application of the liquid crystal display, it is required to obtain a LC margin between low-temperature bubbles and high-temperature gravity Mura (unevenness in the display due to the flow of LC under high temperature and gravity) so as to reduce poor quality products due to an error in the amount of liquid crystal dripped in the mass production, for this purpose, areas on the array substrate, such as a thin film transistor (TFT) switch, a pillow, gate and source scanning lines, are taken into account and the PS is designed to be a multi-stage structure in which a first spacer and a second spacer having different heights are arranged and the height of the first spacer is no greater than the second spacer.

Normally, the second spacer supports an array substrate in a compressed state so as to keep the uniformity of the cell gap, while the first spacer is at a certain distance from the array substrate. When the display panel is subjected to a vertical external force or at a low temperature, the cell gap will be narrowed, the CF substrate will approach the array substrate, and the second spacer will fail to provide sufficient support due to undergoing excessive pressure, and in this case, the first spacer will make contact with the array substrate and provide sufficient support for the array substrate and thereby keep the uniformity of the cell gap.

### SUMMARY

In view of the above, the present disclosure provides a display substrate assembly, a display panel and its manufacturing method, and a display device, in which slip of the second spacer for maintaining the cell gap can be prevented when the panel is subjected to a horizontal external force.

For this purpose, the present disclosure provides, in one embodiment, a display substrate assembly, which comprises a display substrate, a first spacer and a second spacer arranged at one side of the display substrate wherein a height of the first spacer is no greater than a height of the second spacer, and a pressure-sensitive adhesive layer arranged at an end of the second spacer away from the display substrate.

In one example, a thickness of the pressure-sensitive adhesive layer is 1 to 30 nm.

In one example, the thickness of the pressure-sensitive adhesive layer is 10 nm.

In one example, the pressure-sensitive adhesive layer comprises a pressure-sensitive adhesive which comprises at least one of a styrene-isoprene-styrene block copolymer, a styrene-butadiene-styrene block copolymer, a hydrogenated styrene-butadiene block copolymer, a hydrogenated styrene-isoprene block copolymer, and an epoxidized styrene-butadiene-styrene block polymer.

In one example, the height of the first spacer is less than the height of the second spacer.

In one example, the height of the first spacer is equal to the height of the second spacer, and the display substrate assembly further comprises a pressure-sensitive adhesive layer arranged at an end of the first spacer away from the display substrate.

Meanwhile, the present disclosure further provides, in one embodiment, a display panel, where comprises a first substrate assembly and a second substrate assembly which are arranged opposite to each other to form a cell, wherein the first substrate assembly comprises a first substrate, the second substrate assembly is the display substrate assembly provided by any of the embodiments of the present disclosure and comprises a second substrate as the display substrate, and the spacers are arranged between the first substrate and the second substrate.

In one example, the first substrate is an array substrate and the second substrate is a color filter substrate.

Further, the present disclosure provides a display device, which comprises the display panel provided by any of the embodiments of the present disclosure.

Further, the present disclosure provides in one embodiment a method of manufacturing a display panel, which comprises:

providing a first substrate assembly, and a second substrate in a second substrate assembly;

arranging a first spacer and a second spacer at one side of the second substrate wherein a height of the first spacer is no greater than a height of the second spacer, and arranging a pressure-sensitive adhesive layer at an end of the second spacer away from the second substrate.

In one example, the method further comprises:

dripping liquid crystal at a preset position of the second substrate assembly or the first substrate assembly and coating a sealant;

performing coarse alignment and fine alignment of the second substrate assembly with the first substrate assembly in a vacuum environment;

pressing the second substrate assembly and the first substrate assembly together so that the second spacer is stuck and fixed onto a preset position of the first substrate assembly via the pressure-sensitive adhesive layer.

As can be seen from the above, in the display substrate assembly, the display panel, the display device and the method of manufacturing a display panel provided in the present disclosure, a pressure-sensitive adhesive layer is provided at the end of the second spacer for maintaining the cell gap. When the display substrate assembly and an opposite substrate assembly are arranged opposite to each other to form a cell, the pressure-sensitive adhesive layer will stick to a specified position of the opposite substrate assembly under the pressure of alignment for forming the cell, and thereafter, the second spacer will not slip when the panel is subjected to a horizontal force. As a result, PS Mura due to the slip of the spacer as well as the damage to other structures inside the display panel due to the slip of the spacer will be prevented.

### BRIEF DESCRIPTION OF THE DRAWINGS

FIG. 1A is a schematic diagram of a display panel in a normal state in the related art;

FIG. 1B is a schematic diagram of a display panel in a state where the CF substrate and the array substrate are shifted with respect to each other under a horizontal external force in the related art;

FIG. 2A is a structural schematic diagram of a display substrate assembly of one embodiment of the present disclosure;

FIG. 2B is a schematic diagram of a display panel, of one embodiment of the present disclosure, which is shifted under a horizontal external force.

### DETAILED DESCRIPTION

The present disclosure will be described below in detail in conjunction with the accompanying drawings and embodiments, in order to make the technical problems to be solved, the technical solutions and advantages of the present disclosure more clear.

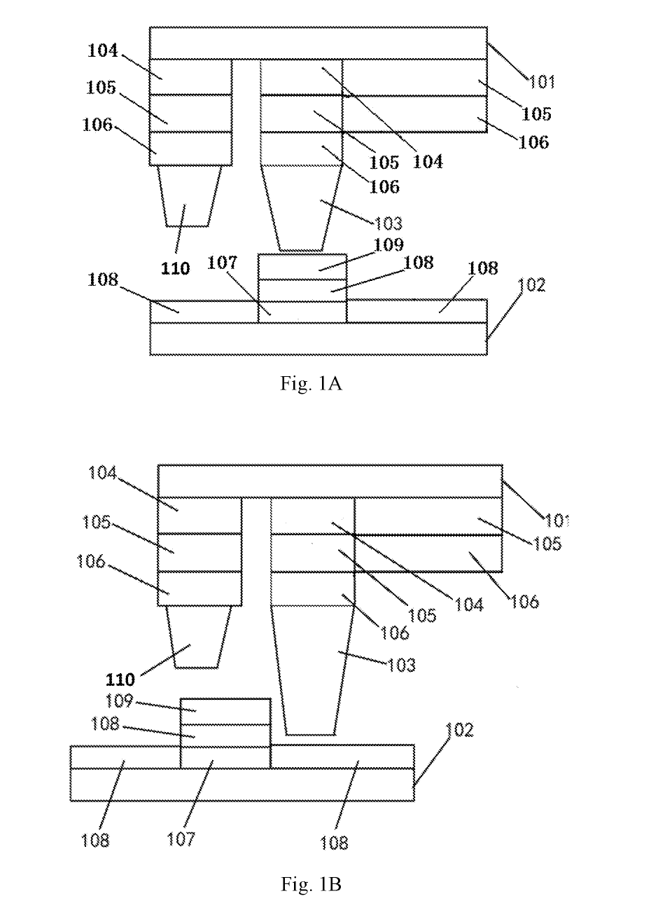

When a display panel is in a normal state, as shown in FIG. 1A, a second spacer 103, a black matrix 104, a color filter layer 105 and an overlay 106 are arranged on a CF substrate 101, wherein the second spacer 103 is located at a preset position on the overlay 106, the black matrix 104 is connected with the CF substrate 101, and the color filter layer 105 is arranged at a specified position on the CF substrate 101 where no black matrix 104 is arranged, or the color filter layer 105 is arranged between the overlay 106 and the black matrix 104. A gate 107, a gate insulating layer 108, an active layer 109 are sequentially arranged on an array substrate 102, wherein the gate 107 is arranged at a specified position on the array substrate 102, the gate insulating layer 108 is arranged on the array substrate 102 or the gate 107, and the active layer 109 is arranged on the gate insulating layer 108. When the display panel is subjected to a horizontal external force, as shown in FIG. 1B, the CF substrate 101 and the array substrate 102 are shifted with respect to each other, and the second spacer 103 in a compressed state may move away from its original area (such as pillow, TFT switch and other positions) to result in a slip; and the first spacer 110 does not make contact with the array substrate 102. In this case, it will at least make the second spacer unable to restore quickly and result in poor performance of the gap, and worst of all, the second spacer may scratch a guide film made of polymide (PI) at the side of the array substrate, thereby affecting the normal alignment of the LC and resulting in PS Mura.

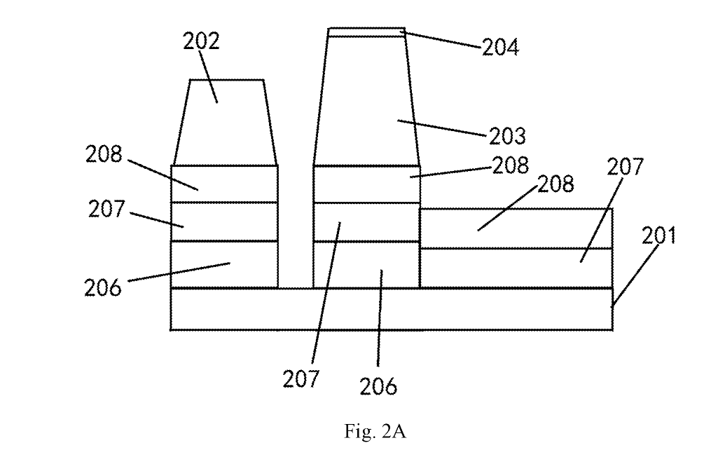

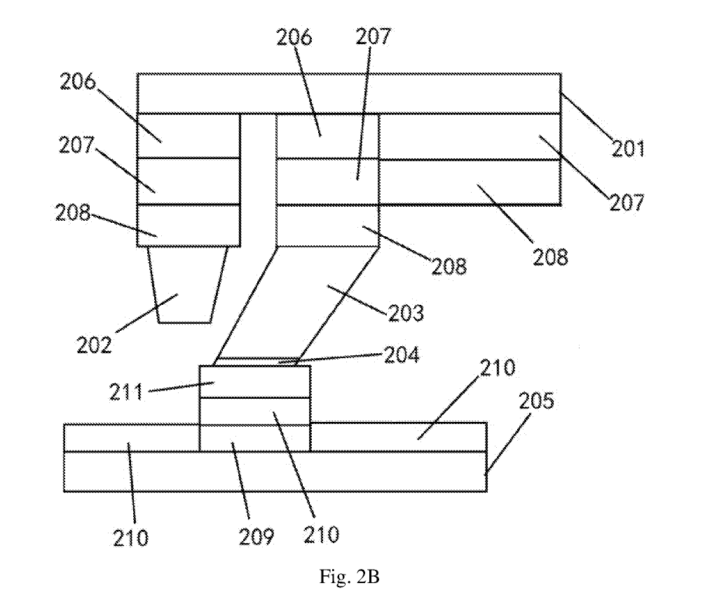

In order to solve such technical problems, the present disclosure first provides in one embodiment a display substrate assembly which has a structure as shown in FIG. 2A that comprises a display substrate 201, a first spacer 202 and a second spacer 203 arranged at one side of the display substrate 201 wherein the height of the first spacer 202 is no greater than the height of the second spacer 203, and a pressure-sensitive adhesive layer 204 arranged at the end of the second spacer 203 away from the display substrate 201.

As can be seen from the above, in the display substrate assembly provided in the present disclosure, a pressure-sensitive adhesive layer is provided at the end of the second spacer for maintaining the cell gap away from the display substrate. When the display substrate assembly and its opposite substrate assembly are arranged opposite to each other to form a cell, a pressure will be applied to them, which will allow the pressure-sensitive adhesive layer to be stuck to the preset position on the opposite substrate assembly. In this case, when the display panel is subjected to a horizontal external force or when the display substrate and the opposite substrate are shifted with respect to each other, the second spacer will not slip, thereby preventing PS Mura due to the slip of the second spacer. Meanwhile, in the present disclosure, the pressure-sensitive adhesive layer is used as an adhesive layer, which can avoid the sticking together of the display substrate assembly and the opposite substrate assembly when they are not aligned, as well as the drying and loss of sticking effect of the adhesive when it takes a long period of time to arrange the display substrate assembly and the opposite substrate assembly opposite to each other to form a cell.

A person skilled in the art should understand that the display substrate assembly is also provided with other structures that should be provided for the display substrate assembly. For example, in the embodiment shown in FIG. 2A, the display substrate assembly is further provided with a black matrix 206, a color filter layer 207 and an overlay 208.

Pressure-sensitive adhesive is a type of adhesives which are sensitive to pressure, and is mainly used for manufacturing pressure-sensitive tapes. Generally: peel-off force of a pressure-sensitive adhesive <cohesion of an adhesive <substrate-binding force of the adhesive, wherein the peel-off force of a pressure-sensitive adhesive is a peel-off force exhibited between the adhensive tape and the adhered surface which are pressed and stuck to each other, the cohesion of the adhesive is the intermolecular force of the pressure-sensitive adhesive, and the substrate-binding force of the adhesive is an adhesive force between the adhesive and the substrate. In one embodiment of the present disclosure, the second spacer is used as a substrate for the pressure-sensitive adhesive layer.

In one example of the present disclosure, the display substrate may be an array substrate or a color filter substrate.

In one example of the present disclosure, when the height of the first spacer is less than the height of the second spacer, no pressure-sensitive adhesive layer is arranged at the end of the first spacer away from the display substrate.

In order to prevent the pressure-sensitive adhesive from affecting the display substrate or the opposite substrate and other elements between the display substrate and the opposite substrate, in one example of the present disclosure, the pressure-sensitive adhesive layer is a solid adhesive layer.

In one example of the present disclosure, the thickness of the pressure-sensitive adhesive layer is 1 to 30 nm.

In one example of the present disclosure, the thickness of the pressure-sensitive adhesive layer is 10 nm.

In one example of the present disclosure, a pressure-sensitive adhesive mainly composed of styrene-based thermoplastic elastomers is used. For example, the pressure-sensitive adhesive may comprise at least one of a styrene-isoprene-styrene block copolymer (SIS), a styrene-butadiene-styrene block copolymer (SBS), a hydrogenated styrene-butadiene block copolymer (SEBS), a hydrogenated styrene-isoprene block copolymer (SEPS), and an epoxidized styrene-butadiene-styrene block polymer (epoxidized SBS).

In one example, the pressure-sensitive adhesive may be a mixture of various substances.

SIS and SBS both have dural characteristics of rubber and plastic, and they are easy to get, moderate in price and very suitable for use as the elastomer assembly of the pressure-sensitive adhesives. SIS shows great elasticity and is resistant to water, alcohols, weak acids and weak bases, and can be only dissolved or swelled in esters, ketones and hydrocarbons. Liquid crystal materials are mainly organic polymers such as aliphatic polymers, aromatic polymers, stearic acids. SIS pressure-sensitive adhesive can be stable in liquid crystal without being dissolved. Therefore, in one example of the present disclosure, the pressure-sensitive adhesive is SIS and/or SBS.

In one example of the present disclosure, the height of the first spacer is less than the height of the second spacer. The first spacer and the second spacer may be set to have the same height or different heights so as to meet the requirement of supporting the display substrate and the opposite substrate in different cases.

In one example of the present disclosure, when the height of the first spacer is equal to the height of the second spacer, a pressure-sensitive adhesive layer is also arranged at the end of the first spacer away from the display substrate.

Further, the present disclosure provides in one embodiment a display panel, which comprises a first substrate assembly, and a second substrate assembly which are arranged opposite to each other to form a cell, wherein the first substrate assembly comprises a first substrate, the second substrate assembly is the display substrate assembly provided by any of the embodiments of the present disclosure and comprises a second substrate as the display substrate, and the spacer are arranged between the first substrate and the second substrate. When subjected to an external force, as shown in FIG. 2B, the second spacer 203 has one end fixed on the second substrate 201, and the other end stuck to the first substrate 205 via the pressure-sensitive adhesive layer 204, and thus will not slip.

A person skilled in the art shall understand that, the first substrate assembly may be also provided with other structures that should be provided on the display substrate assembly. For example, in the embodiment shown in FIG. 2B, the first substrate assembly is further sequentially provided with a gate 209, a gate insulating layer 210 and an active layer 211.

In one example of the present disclosure, the first substrate is an array substrate and the second substrate is a color filter substrate.

Further, the present disclosure further provides in one embodiment a display device, which comprises the display panel provided in any of the embodiments of the present disclosure.

The present disclosure further provides in one embodiment a method of manufacturing a display panel, which comprises:

Step 301: providing a first substrate assembly and a second substrate in a second substrate assembly;

Step 302: arranging a first spacer and a second spacer at one side of the second substrate wherein the height of the first spacer is no greater than the height of the second spacer, and arranging a pressure-sensitive adhesive layer at the end of the second spacer away from the second substrate, wherein the second spacer functions as a substrate for the pressure-sensitive adhesive layer.

As compared with a traditional manufacturing process of a substrate, a layer of solid pressure-sensitive adhesive is coated on the surface of the second spacer in the method of manufacturing a display panel provided in the present disclosure. After the completion of vacuumization and alignment of the array substrate and the CF substrate by using a Vacuum Alignment System (VAS) device, the two substrates will be stuck together. The CF substrate gradually approaches the array substrate, the second spacer begins to make contact with the array substrate and is compressed under an external pressure. During this process, the solid pressure-sensitive adhesive on the surface of the second spacer adheres to the surface of the array substrate after being gradually compressed, so as to form stable adhesion therebetween. By using the pressure-sensitive adhesive, the PS is firmly stuck to the array substrate, and normal functions of compression and maintaining cell gap of the PS are not affected. After this treatment, when the CF substrate and the array substrate comprising a TFT are horizontally shifted under an external force, the PS will not be broke away and its restoration will not be affected, in addition, the PI alignment film at the TFT side will not be scratched, and PS Mura or poor performance of the gap will be avoided.

In one example of the present disclosure, the method further comprises:

dripping liquid crystal at a preset position of the second substrate assembly or the first substrate assembly and coating a sealant;

performing coarse alignment and fine alignment of the second substrate assembly with the first substrate assembly in a vacuum environment; and

pressing the second substrate assembly and the first substrate assembly together so that the second spacer is stuck and fixed onto a preset position of the first substrate assembly via the pressure-sensitive adhesive layer.

In one example of the present disclosure, prior to One Drop Fill (ODF) process in a liquid crystal cell factory, one end of the second spacer on the CF substrate is coated with a layer of pressure-sensitive adhesive comprising styrene-isoprene-styrene block copolymer (SIS) having a thickness of 10 nm. Liquid crystal (LC) is dripped on the surface of the array substrate comprising a TFT, a sealant is coated on the surface of the CF substrate, and the two substrates are sequentially subjected to pump vacuum, coarse alignment and fine alignment, and pressing together, in a VAS instrument. During this process, the CF substrate gradually approaches the array substrate, and the second spacer also gradually makes contact with the TFT and will be compressed. The pressure-sensitive adhesive at the end of the second spacer reacts to firmly stick the second spacer to a fixed position on the surface of the array substrate. The second spacer in the compressed state together with the filled liquid crystal supports the display panel so as to maintain the uniformity of the cell gap.

In the method of manufacturing the display panel provided by the present disclosure, a thin layer of pressure-sensitive adhesive is coated on the surface of the second spacer. When the array substrate and the CF substrate are vacuumized, aligned and attached together in the VAS device, the main PS makes contact with the array substrate comprising a TFT and is compressed, and the pressure-sensitive adhesive play its role to firmly stick the PS to the fixed position on the surface of the TFT. As a result, poor performance of gap and PS Mura are avoided when the CF substrate and the array substrate comprising the TFT are shifted with respect to each other.

As can be seen from the above, in the display substrate assembly, the display panel, the display device and the method of manufacturing a display panel provided in the present disclosure, a pressure-sensitive adhesive layer is provided at the end of the second spacer for supporting the cell gap. When the display substrate assembly and its opposite substrate assembly are arranged opposite to each other to form a cell, the pressure-sensitive adhesive layer will stick to a specified position on the opposite substrate assembly under the pressure for forming the cell, and thereafter, the second spacer will not slip when subjected to a horizontal force. Thus, PS Mura due to the slip of the spacer as well as the damage to other structures inside the display panel due to the slip of the spacer will be prevented.

It shall be understood that, the various embodiments described in the specification are merely for describing and explaining the present disclosure, and are not intended to limit the present disclosure. Moreover, features in the examples and embodiments in the present application can be combined without conflict. Obviously, a person skilled in the art may make various changes and modifications to the present disclosure without departing from the spirit and scope of the present disclosure. Therefore, if these changes and modifications fall within the scope of the claims of the present application and equivalent technologies thereof, such changes and modifications will be intended to be encompassed by the present disclosure.

What is claimed is:

1. A display substrate assembly, comprising a display substrate, a first spacer and a second spacer arranged at one side of the display substrate, wherein a height of the first spacer is not greater than a height of the second spacer, and a pressure-sensitive adhesive layer is arranged at an end of the second spacer away from the display substrate.

2. The display substrate assembly according to claim 1, wherein a thickness of the pressure-sensitive adhesive layer is 1 to 30 nm.

3. The display substrate assembly according to claim 2, wherein the thickness of the pressure-sensitive adhesive layer is 10 nm.

4. The display substrate assembly according to claim 1, wherein the pressure-sensitive adhesive layer comprises a pressure-sensitive adhesive which comprises at least one of a styrene-isoprene-styrene block copolymer, a styrene-butadiene-styrene block copolymer, a hydrogenated styrene-butadiene block copolymer, a hydrogenated styrene-isoprene block copolymer, and an epoxidized styrene-butadiene-styrene block polymer.

5. The display substrate assembly according to claim 1, wherein the height of the first spacer is less than the height of the second spacer.

6. The display substrate assembly according to claim 1, wherein the height of the first spacer is equal to the height of the second spacer, and the display substrate assembly further comprises a pressure-sensitive adhesive layer arranged at an end of the first spacer away from the display substrate.

7. A display panel, comprising a first substrate assembly and a second substrate assembly which are arranged opposite to each other to form a cell, wherein the first substrate assembly comprises a first substrate, the second substrate assembly is the display substrate assembly according to claim 1 and comprises a second substrate as the display substrate, and the first spacer and the second spacer are arranged between the first substrate and the second substrate.

8. The display panel according to claim 7, wherein the first substrate is an array substrate and the second substrate is a color filter substrate.

9. The display panel according to claim 7, wherein a thickness of the pressure-sensitive adhesive layer is 1 to 30 nm.

10. The display panel according to claim 9, wherein the thickness of the pressure-sensitive adhesive layer is 10 nm.

11. The display panel according to claim 7, wherein the pressure-sensitive adhesive layer comprises a pressure-sensitive adhesive which comprises at least one of a styrene-isoprene-styrene block copolymer, a styrene-butadiene-styrene block copolymer, a hydrogenated styrene-butadiene block copolymer, a hydrogenated styrene-isoprene block copolymer, and an epoxidized styrene-butadiene-styrene block polymer.

12. The display panel according to claim 7, wherein the height of the first spacer is less than the height of the second spacer.

13. The display panel according to claim 7, wherein the height of the first spacer is equal to the height of the second spacer, and the second substrate assembly further comprises a pressure-sensitive adhesive layer arranged at an end of the first spacer away from the second substrate.

14. A display device, comprising the display panel according to claim 7.

15. The display device according to claim 14, wherein the first substrate is an array substrate and the second substrate is a color filter substrate.

16. The display device according to claim 14, wherein a thickness of the pressure-sensitive adhesive layer is 1 to 30 nm.

17. The display device according to claim 16, wherein the thickness of the pressure-sensitive adhesive layer is 10 nm.

18. The display device according to claim 14, wherein the pressure-sensitive adhesive layer comprises a pressure-sensitive adhesive which comprises at least one of a styrene-isoprene-styrene block copolymer, a styrene-butadiene-styrene block copolymer, a hydrogenated styrene-butadiene block copolymer, a hydrogenated styrene-isoprene block copolymer, and an epoxidized styrene-butadiene-styrene block polymer.

19. A method of manufacturing a display panel, comprising:
providing a first substrate assembly, and a second substrate in a second substrate assembly;
arranging a first spacer and a second spacer at one side of the second substrate wherein a height of the first spacer is not greater than a height of the second spacer, and arranging a pressure-sensitive adhesive layer at an end of the second spacer away from the second substrate.

20. The method according to claim 19, further comprising:
dripping liquid crystal at a preset position of the second substrate assembly or the first substrate assembly and coating a sealant;
performing coarse alignment and fine alignment of the second substrate assembly with the first substrate assembly in a vacuum environment; and
pressing the second substrate assembly and the first substrate assembly together so that the second spacer is stuck and fixed onto a preset position of the first substrate assembly via the pressure-sensitive adhesive layer.
